(19) United States
(12) Patent Application Publication
(10) Pub. No.: US 2026/0032432 A1
(43) Pub. Date: Jan. 29, 2026

(54) SECURE UNCREWED AERIAL VEHICLE DIRECT COMMUNICATIONS

(71) Applicant: LENOVO (SINGAPORE) PTE. LTD., Singapore (SG)

(72) Inventors: Sheeba Backia Mary BASKARAN, Friedrichsdorf (DE); Andreas KUNZ, Ladenburg (DE)

(21) Appl. No.: 19/099,199

(22) PCT Filed: Aug. 1, 2023
(86) PCT No.: PCT/IB2023/057809

§ 371 Date: Jan. 28, 2025

Related U.S. Application Data
(60) Provisional application No. 63/394,256, filed on Aug. 1, 2022.

(51) Int. Cl. H04W 12/03; H04W 12/08

(52) U.S. Cl. CPC H04W 12/03; H04W 12/08

(57) ABSTRACT

Various aspects of the present disclosure relate to a user equipment (UE) for wireless communication configured to receive an aircraft-to-everything (A2X) security policy and sends, to a uncrewed aerial vehicle (UAV) controller (UAV-C), a request for direct communication and associated with a UAV service. The request message includes the A2X security policy. The UE may receive, from the UAV-C, a response based on verifying the A2X security policy, where the response indicates whether the request for the UAV service is accepted or rejected. The UE may experience a decreased likelihood of being compromised by a malicious attacker (e.g., a malicious UE).

### CROSS REFERENCE

The present Application claims priority to U.S. Patent Application No. 63/394,256 filed Aug. 1, 2022 entitled “METHOD AND APPARATUS FOR SECURE UAV DIRECT COMMUNICATIONS,” assigned to the Assignee hereof, and expressly incorporated by reference herein.

### TECHNICAL FIELD

The present disclosure relates to wireless communications, and more specifically to secure uncrewed aerial vehicle (UAV) communications.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G.

The wireless communications system, for example, a 5G system may be configured to support functionality and operability in accordance with 3GPP Release 17. For example, the 5G system may be configured with various parameters to support wireless communications with UAVs. The functionality and operability of the 5G system in accordance with Release 17 may experience limited security protocols for UAV communications and, as a result, may be susceptible to potential security vulnerabilities.

### SUMMARY

The present disclosure relates to methods, apparatuses, and systems that support security improvements for command and control operations (also referred to as C2 operations) of UAVs in a wireless communications system, as well as for detect and avoid (DAA) operations for UAVs operating in the wireless communications system (e.g., a 5G system). These security improvements reduce the likelihood of attackers gaining control over a UAV or eavesdropping (e.g., listening, intercepting) UAV communications associated with the UAV.

Some implementations of apparatuses described herein may further include a user equipment (UE) for wireless communication including at least one memory, and at least one processor coupled with the at least one memory and configured to cause the UE to receive an aircraft-to-everything (A2X) security policy, send, to an uncrewed aerial vehicle (UAV) controller (UAV-C), a request for direct communication and associated with a UAV service, wherein the request includes the A2X security policy, and receive, from the UAV-C, a response based at least in part on verifying the A2X security policy, wherein the response indicates whether the request for the UAV service is accepted or rejected.

Some implementations of the method described herein may further include a method performed by a user equipment (UE), the method including receiving an aircraft-to-everything (A2X) security policy, sending, to an uncrewed aerial vehicle (UAV) controller (UAV-C), a request for direct communication and associated with a UAV service, wherein the request includes the A2X security policy, and receiving, from the UAV-C, a response based at least in part on verifying the A2X security policy, wherein the response indicates whether the request for the UAV service is accepted or rejected.

In some implementations of the method and apparatuses described herein, the the UAV service comprises a command and control (C2) service or a detect and avoid (DAA) service.

In some implementations of the method and apparatuses described herein, the A2X security policy comprises one or more of: an A2X PC5 security policy for A2X C2 and DAA services, an A2X C2 security policy for one or both of signaling and user plane operations, and an A2X DAA security policy for one or both of signaling and user plane operations.

In some implementations of the method and apparatuses described herein, the A2X security policy is a C2 security policy, and signaling and user plane security operations are set as required based on local policy.

In some implementations of the method and apparatuses described herein, the U2X security policy comprises a set of identifiers of a set of UAVs or a set of UAV-Cs for which the direct communication is permitted or prohibited, or a combination thereof.

In some implementations of the method and apparatuses described herein, the request comprises one or more of a UAV identifier, a UAV-C identifier, a security capability for the direct communication, or security key information.

In some implementations of the method and apparatuses described herein, the UAV service is a command and control (C2) service, and wherein, to verify the A2X security policy, the at least one processor is configured to cause the UE to: compare an identifier of the UAV-C to a set of identifiers of a set of UAVs or a set of UAV-Cs for which the direct communication is permitted or prohibited, or a combination thereof, compare the A2X security policy to a received security capability of the UAV-C, and confirm that the UAV-C is authorized based at least in part on the identifier of the UAV-C matching a respective identifier of the set of UAV-Cs for which the direction communication is permitted.

In some implementations of the method and apparatuses described herein, the at least one processor is configured to cause the UE to: receive, from the UAV-C, a direct security mode message including one or more of: information elements of a received A2X service type in the request, information elements of the A2X security policy in the request, s security capability, or the A2X security policy received from the UAV and an agreed A2X service security policy.

In some implementations of the method and apparatuses described herein, the A2X service type comprises a detect and avoid (DAA) service, and wherein at least one processor is configured to cause the UE to transmit a second request to a second UAV.

In some implementations of the method and apparatuses described herein, the UE is a UAV, and at least one processor is configured to cause the UE to receive, from the UAV-C, a direct security mode message including an identifier of the UAV and an identifier of the UAV-C, receive, from the UAV-C, a direct security mode command message, and transmit, to the UAV-C, a response as a direct security mode complete message to the direct security mode command message including information elements from the request.

### BRIEF DESCRIPTION OF THE DRAWINGS

FIG. 1 illustrates an example of a wireless communications system that supports secure UAV communications in accordance with aspects of the present disclosure.

FIG. 2 illustrates an example of a wireless communications system that supports secure UAV communications in accordance with aspects of the present disclosure.

FIG. 3 illustrates an example of a block diagram of a device that supports secure UAV communications in accordance with aspects of the present disclosure.

FIGS. 4 through 7 illustrate signaling diagrams that support devices and methods of secure UAV communications in accordance with aspects of the present disclosure.

FIG. 8 illustrates an example of a block diagram of a processor that supports secure UAV communications in accordance with aspects of the present disclosure.

### DETAILED DESCRIPTION

A wireless communications system, such as an unmanned aerial system (UAS) (also referred to as an uncrewed aerial system or an aircraft system) may support communications for one or multiple UAVs. For example, a UAV-controller (UAV-C) may use a communication link (e.g., a PC5 unicast link, a Command and Control (C2) link) to control one or more UAVs for C2 operations. Additionally, or alternatively, the one or more UAVs may communicate (e.g., receive, transmit) with each other using a communication link, such as a PC5 unicast link to perform DAA operations, among other examples. Some UAVs may be unable to authenticate or authorize communication links (e.g., connections) associated with C2 and DAA operations.

If a UAV can be controlled using C2 over PC5 by another UAV or UAV-C that established direct communication for DAA operations, it could pose significant threats to the UAV. For example, a lack of operation-specific (e.g., C2/DAA) direct communication authentication and authorization may enable the other UAV or UAV-C that gained direct communication for DAA operations, to maliciously engage in C2 operations, leading to hijacking of the UAV and launching serious attacks. Additionally, if UAV-to-everything (U2X) or Aircraft-to-everything (A2X) services are deployed (e.g., applied, implemented) with security policies such as ‘NOT needed/Preferred’, it can result in additional threats. The lack of security for the communication link (e.g., a PC5 unicast link) between a UAV and a UAV-C used for communication (e.g., C2 operations, DAA operations) may allow attackers eavesdrop and gain control over UAV operations, thereby leading to UAV hijacking and mis-operations. In the following disclosure, although embodiments are described with respect to U2X services, the embodiments may be implemented for A2X services. That is, the terms “U2X” and “A2X” may be used interchangeably throughout this disclosure.

Various aspects of the present disclosure relate to UAV communication, including UAS/U2X/A2X direct communication, including U2X service specific direct authentication and/or authorization and, U2X security policy configuration and enforcement. These various aspects may ensure security for UAV communication (e.g., C2 direct communication, DAA direct communication). For example, UAVs can provide direct authentication and key establishment related to C2 communications for authorized UAV-Cs to prevent unauthorized UAVs, UAV-Cs, and other UEs from being involved in direct authentication and key establishment. A security policy can be configured within a network (e.g., a 5G system) and provisioned to UEs involved in U2X services, such as C2 services and DAA services, to ensure secure direct connection/unicast link establishment between a UAV and a UAV-C for C2 operations, and between UAVs for DAA operations, while reducing the likelihood of an unauthorized entity compromising a UAV or UAV-C.

Aspects of the present disclosure are described in the context of a wireless communications system. Aspects of the present disclosure are further illustrated and described with reference to device diagrams, flowcharts that relate to secure UAV communications.

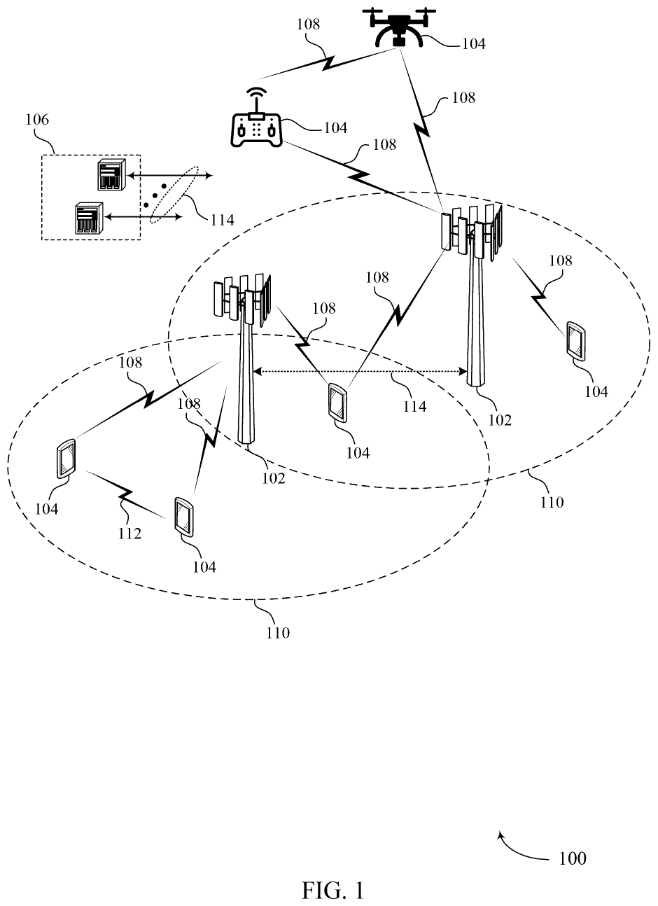

FIG. 1 illustrates an example of a wireless communications system 100 that supports secure UAV communications in accordance with aspects of the present disclosure. The wireless communications system 100 may include one or more base stations 102, one or more UEs 104, and a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be or include or may be referred to as a base transceiver station, an access point, a NodeB, an eNodeB (eNB), a next-generation NodeB (gNB), or other suitable terminology. A base station 102 and a UE 104 may communicate via a communication link 108, which may be a wireless or wired connection. For example, a base station 102 and a UE 104 may wireless communication over a Uu interface.

A base station 102 may provide a geographic coverage area 110 for which the base station 102 may support services (e.g., voice, video, packet data, messaging, broadcast, etc.) for one or more UEs 104 within the geographic coverage area 110. For example, a base station 102 and a UE 104 may support wireless communication of signals related to services (e.g., voice, video, packet data, messaging, broadcast, etc.) according to one or multiple radio access technologies. In some implementations, a base station 102 may be moveable, for example, a satellite associated with a non-terrestrial network. In some implementations, different geographic coverage areas 110 associated with the same or different radio access technologies may overlap, but the different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the base stations 102, other UEs 104, or network equipment (e.g., the core network 106, a relay device, an integrated access and backhaul (IAB) node, or another network equipment), as shown in FIG. 1. Additionally, or alternatively, a UE 104 may support communication with other base stations 102 or UEs 104, which may act as relays in the wireless communications system 100.

A UE 104 may also be able to support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 114 (e.g., via an S1, N2, N2, or another network interface). The base stations 102 may communication with each other over the backhaul links 114 (e.g., via an X2, Xn, or another network interface). In some implementations, the base stations 102 may communicate with each other directly (e.g., between the base stations 102). In some other implementations, the base stations 102 may communicate with each other or indirectly (e.g., via the core network 106). In some implementations, one or more base stations 102 may include subcomponents, such as an access network entity, which may be an example of an access node controller (ANC). An ANC may communication with the one or more UEs 104 through one or more other access network transmission entities, which may be referred to as a radio heads, smart radio heads, or transmission-reception points (TRPs).

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

In the wireless communications system 100, a UE 104 may be a UAV and a UAV-C. A UAV-C may be configured to transmit control signals (e.g., control information) to a UAV. Both the UAV and the UAV-C may receive and/or transmit control information or data by a radio link 108 with one or more base station 102. In some implementations, a UAV-C may serve as a relay to convey communications between a UAV and a base station 102. The core network 106 may be in communication with a UAS service supplier (USS) 116, which may help to enable the safe, secure, and efficient use of airspace associated with the wireless communications system 100. The USS 116 may operate or function as a communication bridge between authorities and drone operators, and often provide tools to monitor the airspace, execute safe missions, and store operational data.

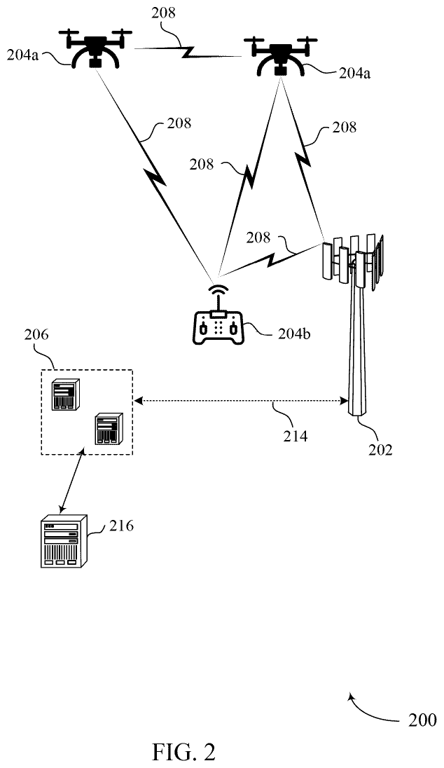

FIG. 2 illustrates an example of a wireless communication system 200 that supports secure UAV communications in accordance with aspects of the present disclosure. The wireless communications system 200 may implement aspects of the wireless communications system 100 as described with reference to FIG. 1. For example, the wireless communications system 200 may include a UAV 204a and a UAV-c 204b, which may be examples of a UE 104 as described with reference to FIG. 1. The wireless communications system 200 may include a base station 202, which may be an example of a base station 102 as described with reference to FIG. 1. Additionally, the wireless communications system 200 may include a core network 206, which may be an example of a core network 106 as described with reference to FIG. 1. In the example of FIG. 2, the wireless communications system 200 may include a USS 216 that may be operated by a third party, such as a municipality or a service provider. The USS 216 may support communication with the core network 206. In some implementations, the USS 216 may be an Uncrewed Aerial System Traffic Management (UTM) entity. The UTM entity may provide a set of functions and services for managing various autonomous vehicle operations.

The core network 206 may support (e.g., host) a plurality of network functions. In the wireless communications system 200, the core network 206 may communicate with the base station 202 over a backhaul 214 (also referred to as a backhaul link). The base station 202 may transmit and receive signals carrying control information and/or data from one or more of the UAV 204a or the UAV-C 204b using communication links 208. The base station 202 may communicate directly with one or both of the UAV 204a and the UAV-C 204b. Alternatively, the base station 202 may communicate with the UAV-C 204b, and the UAV-C 204b may relay communications to one or more of the UAV 204a. Additionally, or alternatively, the base station 202 may perform communications with a first UAV 204a, which may relay the communications to a second UAV 204a or the UAV-C 204b over communication links 208 (e.g., direct communications interface such as PC5 links). The UAV-C 204b may communicate with one or more UAV 204a for C2 operations, and UAVs 204a may communicate with each other for DAA operations.

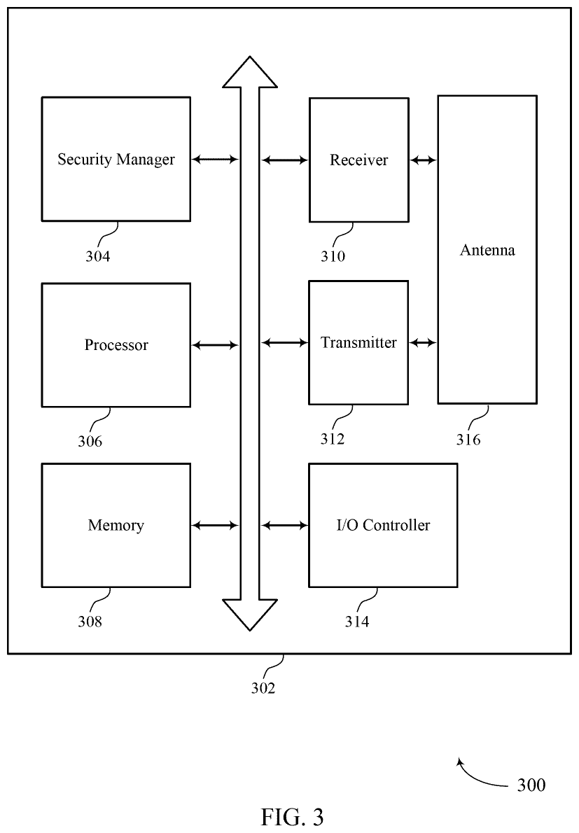

FIG. 3 illustrates an example of a block diagram 300 of a device 302 that supports secure UAV communications in accordance with aspects of the present disclosure. The device 302 may be an example of a base station 102 or a UE 104 as described herein. The device 302 may support wireless communication with one or more base stations 102, UEs 104, or any combination thereof. The device 302 may include components for bi-directional communications including components for transmitting and receiving communications, such as a security manager 304, a processor 306, a memory 308, a receiver 310, transmitter 312, and an I/O controller 314. These components may be in electronic communication or otherwise coupled (e.g., operatively, communicatively, functionally, electronically, electrically) via one or more interfaces (e.g., buses).

The security manager 304, the receiver 310, the transmitter 312, or various combinations thereof or various components thereof may be examples of means for performing various aspects of the present disclosure as described herein. For example, the security manager 304, the receiver 310, the transmitter 312, or various combinations or components thereof may support a method for performing one or more of the functions described herein.

In some implementations, the security manager 304, the receiver 310, the transmitter 312, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 306 and the memory 308 coupled with the processor 306 may be configured to perform one or more of the functions described herein (e.g., by executing, by the processor 306, instructions stored in the memory 308).

Additionally or alternatively, in some implementations, the security manager 304, the receiver 310, the transmitter 312, or various combinations or components thereof may be implemented in code (e.g., as communications management software or firmware) executed by the processor 306. If implemented in code executed by the processor 306, the functions of the security manager 304, the receiver 310, the transmitter 312, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

The security manager 304 may be configured to perform various operations (e.g., receiving, monitoring, transmitting) using or otherwise in cooperation with the receiver 310, the transmitter 312, or both. For example, the security manager 304 may receive information from the receiver 310, send information to the transmitter 312, or be integrated in combination with the receiver 310, the transmitter 312, or both to receive information, transmit information, or perform various other operations as described herein. Although the security manager 304 is illustrated as a separate component, in some implementations, one or more functions described with reference to the security manager 304 may be supported by or performed by the processor 306, the memory 308, or any combination thereof. For example, the memory 308 may store code, which may include instructions executable by the processor 306 to cause the device 302 to perform various aspects of the present disclosure as described herein, or the processor 306 and the memory 308 may be otherwise configured to perform or support such operations.

For example, the security manager 304 may support wireless communication at a first device (e.g., the device 302) in accordance with examples as disclosed herein. The security manager 304 may be configured as or otherwise support secure UAV communications as described with reference to FIGS. 1, 2, and 4 through 7.

The processor 306 may include an intelligent hardware device (e.g., a general- purpose processor, a DSP, a CPU, a microcontroller, an ASIC, an FPGA, a programmable logic device, a discrete gate or transistor logic component, a discrete hardware component, or any combination thereof). In some implementations, the processor 306 may be configured to operate a memory array using a memory controller. In some other implementations, a memory controller may be integrated into the processor 306. The processor 306 may be configured to execute computer-readable instructions stored in a memory (e.g., the memory 308) to cause the device 302 to perform various functions of the present disclosure.

The memory 308 may include random access memory (RAM) and read-only memory (ROM). The memory 308 may store computer-readable, computer-executable code including instructions that, when executed by the processor 306 cause the device 302 to perform various functions described herein. The code may be stored in a non-transitory computer-readable medium such as system memory or another type of memory. In some implementations, the code may not be directly executable by the processor 306 but may cause a computer (e.g., when compiled and executed) to perform functions described herein. In some implementations, the memory 308 may include, among other things, a basic I/O system (BIOS) which may control basic hardware or software operation such as the interaction with peripheral components or devices.

The I/O controller 314 may manage input and output signals for the device 302. The I/O controller 314 may also manage peripherals not integrated into the device 302. In some implementations, the I/O controller 314 may represent a physical connection or port to an external peripheral. In some implementations, the I/O controller 314 may utilize an operating system such as iOS®, ANDROID®, MS-DOS®, MS-WINDOWS®, OS/2®, UNIX®, LINUX®, or another known operating system. In some implementations, the I/O controller 314 may be implemented as part of a processor, such as the processor 306. In some implementations, a user may interact with the device 302 via the I/O controller 314 or via hardware components controlled by the I/O controller 314.

In some implementations, the device 302 may include a single antenna 316. However, in some other implementations, the device 302 may have more than one antenna 316, which may be capable of concurrently transmitting or receiving multiple wireless transmissions. The receiver 310 and the transmitter 312 may communicate bi-directionally, via the one or more antennas 316, wired, or wireless links as described herein. For example, the receiver 310 and the transmitter 312 may represent a wireless transceiver and may communicate bi-directionally with another wireless transceiver. The transceiver may also include a modem to modulate the packets, to provide the modulated packets to one or more antennas 316 for transmission, and to demodulate packets received from the one or more antennas 316.

The present disclosure supports methods related to direct communication, authentication, authorization and key establishment for U2X operations (e.g., U2X services or A2X services). A UE can be provisioned with a list of U2X services, such as C2 and DAA services, along with Provider Service Identifiers (PSIDs) or Intelligent Transport Systems Application Object Identifiers (ITS-AIDs) of V2X applications. The entries in the list may also include geographical areas and their corresponding security policies, which may define whether a security policy is ‘REQUIRED’ for the protection of signaling integrity, signaling confidentiality, user plane integrity, and user plane confidentiality.

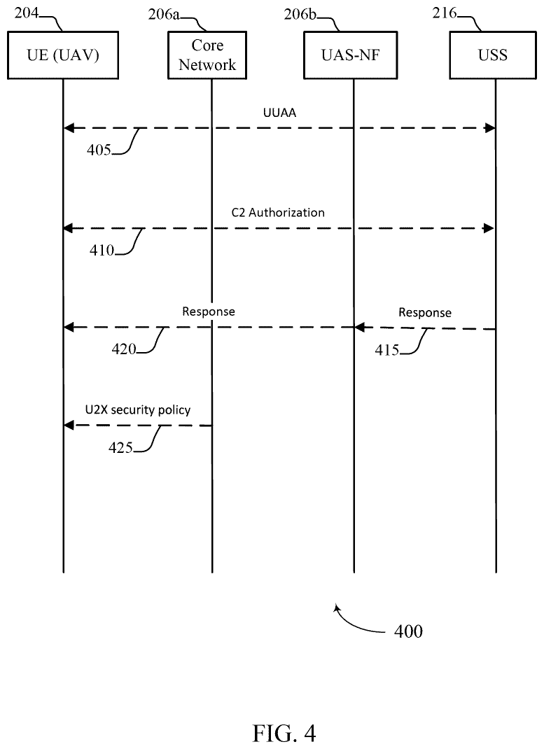

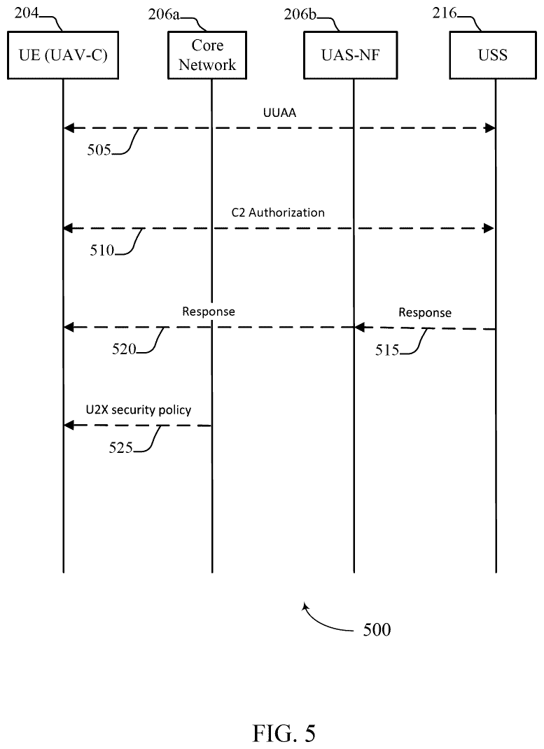

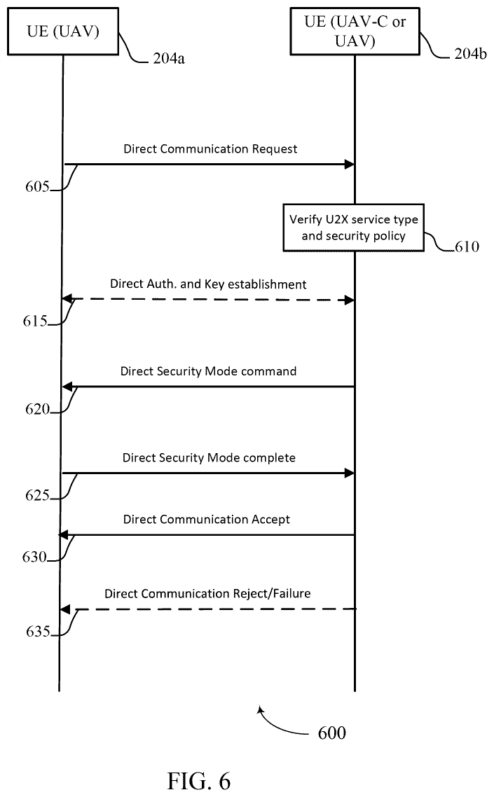

In the following description, FIGS. 4 through 6 illustrate examples of providing security to UAVs. The method of providing security to UAVs includes two phases. The first phase involves USS UAV Authorization/Authentication (UUAA) and C2 authorization for UEs, which includes UAVs and UAV-Cs. Additionally, the first phase includes provisioning the UEs (e.g., UAVs and UAV-Cs) with U2X security policies as describe with reference to FIGS. 4 and 5. The second phase involves establishing a direct U2X service secure connection for C2 and DAA operations as described with reference to FIG. 6.

FIG. 4 illustrates a signaling diagram 400 in accordance with aspects of the present disclosure. The signaling diagram 400 may implement aspects of the wireless communications system 100 and the wireless communications system 200 as described with reference to FIGS. 1 and 2, respectively. For example, the signaling diagram 400 may relate to a UUAA and/or C2 authorization method for a UAV with USS/UTM and provisioning of U2X service specific security policies (e.g., can be specific to A2X service) to a UE (e.g., a UAV, a UAV-C). The signaling diagram 400 may include a UE 204, a core network 206a (e.g., a session management function (SMF), a policy control function (PCF), a network function (NF), or a combination thereof), a UAS-NF 206b, and a USS 216. In some implementations, the USS 216 may be a UTM.

The operations between the UE 204, the core network 206a, the UAS-NF 206b, or the USS 216, or any combination thereof, may occur in a different order or at different times than shown. Additionally, some operations may also be omitted from the signaling diagram 400, and other operations may be added to the signaling diagram 400. In some implementations, the UE 204, the core network 206a, the UAS-NF 206b, and the USS 216 may execute a set of instructions to control the function elements of the UE 204, the core network 206a, the UAS-NF 206b, and the USS 216 to perform the described functions. Additionally, or alternatively, the UE 204, the core network 206a, the UAS-NF 206b, and the USS 216 may perform aspects of the described functions using special-purpose hardware.

At 405, one or more of the UE 204, the core network 206a, the UAS-NF 206b, or the USS 216, or a combination thereof may perform a UUAA procedure. At 410, one or more of the UE 204, the core network 206a, the UAS-NF 206b, or the USS 216, or a combination thereof may perform C2 authorization procedure.

At 415, the USS 216 may transmit, and the UAS-NF 206b may receive, a response message. The response message may be an authentication response or authorization response associated with the UUAA procedure or the C2 authorization procedure, or both. At 420, the UAS-NF 206b may transmit, and the UAV 204 may receive, a response message.

The response message transmitted at 415 and 420 may be an authentication response or authorization response associated with the UUAA procedure or the C2 authorization procedure, or both. In some implementations, the response message may be transmitted directly to the UAV 204, or transmitted to the UAS-NF 206b, which transmits the response message including a security policy for the UAV 204 (e.g., via the core network 206a, such as a SMF or packet data network gateway control plane function (SMF+PGW-C)). Additionally, the response message may include one or more authorized UAV-C identifiers (IDs), such as a civil aviation administration (CAA)-level UAV ID associated with a UAV-C, if the UAV ID is not configured in the UAV 204. Additionally, or alternatively, the response message may include security information for C2 and DAA operations (e.g., C2 and/or DAA direct communications).

In some implementations, the USS 216 may provide a security policy or security requirement information to the UAS-NF 206b in the response message (e.g., an authentication response or authorization response) at 415 and/or at 420. The security policy or requirement information can be specific to each U2X service. For example, the policy or requirement information may be specific to C2 and DAA services. Each U2X security policy may include any of the following for U2X C2 operations and DAA U2X DAA operations respectively: (1) signaling integrity protection: REQUIRED/NOT NEEDED, (2) signaling confidentiality protection: REQUIRED/NOT NEEDED, (3) user plane integrity protection: REQUIRED/NOT NEEDED, or (4) user plane confidentiality protection: REQUIRED/NOT NEEDED, or any combination thereof.

In some implementations, authorized UAV-C information such as UAV-C IDs may be provided to the UAV 204 following a successful UUAA and/or C2 authorization, to allow the UAV 204 to be aware of potential UAV-Cs that can attempt to control the UAV 204 for various purposes. For example, one UAV-C can be a regular controller of the UAV 204 for normal control operation, and another UAV-C may control the UAV 204 for regulatory, safety, or security reasons subject to regulatory requirements. The UAV-C IDs may be provided in an order of priority, which are considered by the UAV 204 while processing and accepting the direct communications with UAV-Cs.

At 425, the core network 206a may transmit, and the UAV 204 may receive, a security policy. The core network 206a can determine or assign a U2X security policy for each service of the UAV 204 specific to U2X C2 operations and U2X DAA operations. In some implementations, the security policy may be based on local configuration or a security policy from the USS 216.

If the UAS NF 206b receives a security policy, which indicates protection as ‘required,’ or if no security policy is received from the USS 216, the UAS-NF 206b can set the U2X security policy as follows for each U2X service, especially for U2X C2 service operations: (1) signaling integrity protection: REQUIRED, (2) signaling confidentiality protection: REQUIRED, (3) user plane integrity protection: REQUIRED, or (4) user plane confidentiality protection: REQUIRED, or any combination thereof. For U2X DAA service operations, the following security policies may be set by an NF of the core network 206a: (1) signaling integrity protection: REQUIRED/PREFERRED, (2) signaling confidentiality protection: REQUIRED/PREFERRED, (3) user plane integrity protection: REQUIRED/PREFERRED, or (4) user plane confidentiality protection: REQUIRED/PREFERRED, or a combination thereof.

If the UAS-NF 206b receives a security policy, which indicates protection as ‘not needed,’ the UAS-NF 206b can set the U2X security policy as follows for each of U2X C2 service operation and for U2X DAA service operations: (1) signaling integrity protection: REQUIRED/PREFERRED/NOT NEEDED, (2) signaling confidentiality protection: REQUIRED/PREFERRED/NOT NEEDED, (3) user plane integrity protection: REQUIRED/PREFERRED/NOT NEEDED, or (4) user plane confidentiality protection: REQUIRED/PREFERRED/NOT NEEDED, or a combination thereof.

The UAS-NF 206b may provide one security policy per U2X service for the C2 and DAA services to the UAV 204 by forwarding via an NF of the core network 206a, such as an AMF or SMF. In some implementations, following at 415, the UAS-NF 206b may transmit a security policy (e.g., if received) and one or more target UAV-C ID with a priority list to the core network 206a (e.g., an SMF) for the UAV 204, which may be identified with a Generic Public Subscription Identifier (GPSI)/3GPP UAV ID or a subscription permanent identifier (SUPI).

In the example of FIG. 4, a network function of the core network 206a, such as SMF may assign a U2X security policy for each service of the UAV specific to U2X C2 operation and U2X DAA operation. The SMF may determine or assign the security policy or in combination with a PCF of the core network 206a, for example, based on a local configuration, a security policy from the UAS-NF 206b, or if the U2X security policy in UDM/UDR is configured as ‘required’ for each U2X services. If the SMF receives a security policy that indicates protection as ‘required’ or if no security policy is received from the USS 216, the UAS-NF 206b can set the U2X security policy as follows for each U2X service, especially for U2X C2 service operations: (1) signaling integrity protection: REQUIRED, (2) signaling confidentiality protection: REQUIRED, (3) user plane integrity protection: REQUIRED, (4) user plane confidentiality protection: REQUIRED, or a combination thereof.

In addition, the SMF of the core network 206a may set the following policies for U2X DAA service operations: (1) signaling integrity protection: REQUIRED/PREFERRED, (2) signaling confidentiality protection: REQUIRED/PREFERRED, (3) user plane integrity protection: REQUIRED/PREFERRED, or (4) user plane confidentiality protection: REQUIRED/PREFERRED, or a combination thereof.

If the UAS-NF 206b receives a security policy that indicates protection as ‘not needed’, the SMF/PCF of the core network 206a may set the U2X security policy as follows for each of the C2 and DAA U2X services: (1) signaling integrity protection: REQUIRED/PREFERRED/NOT NEEDED, (2) signaling confidentiality protection: REQUIRED/PREFERRED/NOT NEEDED, (3) user plane integrity protection: REQUIRED/PREFERRED/NOT NEEDED, (4) user plane confidentiality protection: REQUIRED/PREFERRED/NOT NEEDED. The SMF/PCF of the core network 206a can provide a security policy for each U2X service, such as C2 and DAA services, to the UAV 204 by forwarding via an AMF of the core network 206a.

FIG. 5 illustrates a signal diagram of a UUAA and/or C2 authorization procedure 500 for a UE 204 with USS/UTM 216 and provisioning of U2X service specific security policies to a UE-in this case, a UAV-C, in accordance with aspects of the present disclosure. In another embodiment, the UE 204 may be a UAV. The signaling diagram 400 may implement aspects of the wireless communications system 100 and the wireless communications system 200 as described with reference to FIGS. 1 and 2, respectively. For example, the operations of method 500 may be performed by a UE 204, Core network 206, base station 202, and USS 216 as described with reference to FIGS. 1 through 2. Method 500 may include provisioning of U2X service (alternatively referred to as A2X service) specific security policies to a UE 204. If the UE 204 (UAV-C) is capable of Uu communication, the UAV-C may perform a UUAA procedure and C2 Authorization procedure as illustrated by 505 to 510.

At 505, one or more of the UE 204, the core network 206a, the UAS-NF 206b, or the USS 216, or a combination thereof may perform a USS UAV Authorization Authentication (UUAA procedure).

At 510, one or more of the UE 204, the core network 206a, the UAS-NF 206b, or the USS 216, or a combination thereof may perform C2 Authorization. In some implementations, the USS/UTM 216 transmits a response message, which may be an authentication response or authorization response message, to the UAV-C 204. The response message may contain one or more of the authorized UAV information (or UAV-C information if a UAV is UE 204 and if it initiates 505 or 510) such as identification or addressing information, if not configured already, and may also provide security information for C2 and DAA direct communication. The UAV-C 204 may use the received or configured UAV information to consider the direct C2 connection request and related authentication, authorization, and key establishment.

At 515, a response message is provided from the USS 216 to a network function such as a UAS NF 206b. In some implementations, the USS/UTM 216, following successful UUAA and/or C2 authorization (e.g., related to direct C2 authorization) at 505 and 510, may also provide a response message such as an authentication response or authorization response with a security policy or requirement information to the UAS NF 206b at 515. Alternatively, the security policy can be provisioned by the PCF 206a to the UE 204 (e.g., using a UE policy association establishment or modification procedure via the AMF/SMF). The security policy or requirement information can be specific to each U2X service such as C2, where each U2X security policy may include any of the following for U2X C2 operations: (1) signaling integrity protection: REQUIRED/NOT NEEDED, (2) signaling confidentiality protection: REQUIRED/NOT NEEDED, (3) User plane integrity protection: REQUIRED/NOT NEEDED, or (4) user plane confidentiality protection: REQUIRED/NOT NEEDED, or any combination thereof.

In some implementations, one or more authorized UAV information, such as a list of UAV IDs, may be provided to the UAV-C 204 following a successful UUAA and/or C2 authorization, to allow the UAV-C 204 to be aware of potential UAVs that can be controlled by the UAV-C 204 for various purposes. The authorized UAV information may be provided in a response at 515 or 520, in conjunction with a security policy, or through a separate communication. Alternatively, authorized UAV-C information can be provided if the UE includes a UAV.

At 520, the method may include providing a response message from the UAS-NF 206b to a UAV-C 204. The operations of 520 may be performed in accordance with examples as described herein. In some implementations, aspects of the operations of 520 may be performed by a device as described with reference to FIG. 1.

The UAS NF 206b may determine or assign a U2X security policy for each service of the UAV-C specific to U2X C2 operation. The security policy may be either based on a local configuration or based on security policy from USS/UTM 216. If the UAS NF 206b receives a security policy which indicates protection as ‘required’ or if no security policy is received from the USS/UTM, the UAS NF 206b or PCF 206a can set the U2X security policy as follows for each U2X service, especially for U2X C2 service operations, as follows: (1) signaling integrity protection: REQUIRED, (2) signaling confidentiality protection: REQUIRED, or (3) user plane integrity protection: REQUIRED, or any combination thereof.

If the UAS NF 206b receives a security policy which indicates protection as ‘not needed’, the UAS NF 206b can set the U2X security policy as follows for each U2X service: (1) signaling integrity protection: REQUIRED/PREFERRED/NOT NEEDED, (2) signaling confidentiality protection: REQUIRED/PREFERRED/NOT NEEDED, (3) user plane integrity protection: REQUIRED/PREFERRED/NOT NEEDED, or (4) user plane confidentiality protection: REQUIRED/PREFERRED/NOT NEEDED, or any combination thereof. The UAS NF or PCF 206a can provide a security policy for each U2X service such as C2 and DAA services to the UE by forwarding the security policy by an AMF or SMF.

In some implementations, following 515, the UAS NF 206b may send a security policy (if received) and a target UAV ID list to the SMF for the UE. The target UAVs may be identified with GPSI/3GPP UAV ID or SUPI.

At 525, the method may include providing a U2X security policy from a core network 206a to a UAV-C or UAV 204. The operations of 525 may be performed in accordance with examples as described herein. In some implementations, aspects of the operations of 525 may be performed by a device as described with reference to FIG. 1.

At 525, the core network 206a may determine and/or assign a U2X security policy (either by itself or along with a PCF, based on local configuration, if received based on security policy from UAS NF 206b, if the U2X security policy in UDM/UDR is configured as ‘required’ for each U2X service) for each service of the UAV-C specific to U2X C2 operation. If the SMF receives a security policy which indicates protection as ‘required’ or if no security policy is received from the USS/UTM 216, the UAS NF 206b may set the U2X security policy as follows for each U2X service, especially for U2X C2 service operations: (1) signaling integrity protection: REQUIRED, (2) signaling confidentiality protection: REQUIRED, (3) user plane integrity protection: REQUIRED, or (4) user plane confidentiality protection: REQUIRED, or any combination thereof.

If the UAS NF 206b receives any security policy which indicates protection as ‘not needed’, the core network 206a (e.g., SMF/PCF) can set the U2X security policy as follows for each U2X service: (1) signaling integrity protection: REQUIRED/PREFERRED/NOT NEEDED, (2) signaling confidentiality protection: REQUIRED/PREFERRED/NOT NEEDED, (3) user plane integrity protection: REQUIRED/PREFERRED/NOT NEEDED, or (4) user plane confidentiality protection: REQUIRED/PREFERRED/NOT NEEDED, or any combination thereof.

The core network 206a may provide a security policy for each U2X service to the UE by forwarding via the AMF. In an embodiment, the U2X specific security policy provisioning can be same as described above for a UAV with respect to steps 405-425 for the UAV-C.

In addition, the U2X security policy information configured by the core network 206a, UAS-NF 206b or other NF may include one or more of the following information.

In some implementations, the security policy information includes U2X PC5 direct communication security requirements for each U2X service, which may be referred to as U2X service security policy, U2X signaling and/or user plane security policy. Examples of U2X PC5 direct communication security requirements include: 1) C2 service specific confidentiality and integrity requirement information for signaling and user plane protection, and DAA service specific confidentiality and integrity requirement information for signaling and user plane protection.

In some implementations, the security policy information may include a pairing restrictions list. The pairing restrictions list may include an identifier of one or more UAV or UAV-C with which communications (e.g., for C2 communications) are permitted. This can include information on UAV and UAV-C identifiers that can be discovered or discoverable to each other to establish PC5 connection. In addition, the pairing restrictions list may include information on UAV and UAV-C identifiers (e.g., pairing information) that can be allowed to establish a PC5 connection for C2 service. In an embodiment, this can include a list of UAV and UAV-C IDs that are authorized by the USS/UTM to establish a C2 connection, which can be authorized by a 5G system through a core network 206a, UAS-NF 206b or another NF/NEF/AF to allow PC5 direct connection for C2 service.

In some implementations, the security information includes an access restriction list. The access restriction list may be an UAV to everything PC5 access restriction list which includes an identifier of one or more UAV or UAV-C with which communications (e.g., for DAA) are not permitted. This list may include information for UAVs and/or UAV-Cs identifiers that are forbidden from participating in DAA related communications over a PC5 direct connection. This DAA PC5 access/connection restriction list can be authorized by the 5G system through a UAS NF/SMF/PCF/or any NF/NEF/AF or USS/UTM to restrict a PC5 direct connection for DAA service to malicious UAVs/UAV-Cs.

In some implementations, the security information includes security capabilities. The security capabilities may indicate the confidentiality and integrity algorithms to be used for a U2X service direct communication for C2 service. The security capabilities may indicate confidentiality and integrity algorithms to be used for the U2X service direct communication for DAA service. For U2X service, based on local configuration and U2X security policy, the security capabilities may be set to non-null confidentiality and integrity algorithms for C2 and DAA services related signaling and user plane protection.

U2X security policy information may be stored or configured and managed in the network in the UDM/UDR based on operator local policy.

FIG. 6 illustrates a signal diagram of a method 600 of establishing direct U2X service secure connections for C2 or DAA services. The signal diagram 600 may implement aspects of the wireless communications system 100 and the wireless communications system 200 as described with reference to FIGS. 1 and 2, respectively. For example, the operations of method 600 may be performed by UE 204 including a UAV 204a and UAV-C 204b as described with reference to FIGS. 1 through 2.

In method 600, the UAV 204a may use the UAV-C information and the UAV-C 204b may use UAV information that is pre-configured or obtained during C2 authorization. Although some elements of method 600 are described from the perspective of a UAV 204a communicating with a UAV-C 204b as indicated in FIG. 6, other embodiments are possible. For example, for a DAA service, two UAVs may establish secure communications in method 600.

At 605, the method may include providing a direct communication request from UAV 204a to UAV-C 204b. To set up U2X communications over PC5 at 605, the UAV 204a may send a Direct Communication Request at 605 to initiate a unicast (e.g., layer-2) link establishment. The Direct Communication Request may include one or more of: the UAV's Application Layer ID (e.g. CAA-Level UAV ID or other application layer ID assigned for C2 over PC5), the target UAV identifier (if the request is for a DAA service)/UAV-C identifier (if the request is for a C2 service), U2X service type information (i.e., C2 or DAA service is indicated), U2X service security policy specific to the type of service for C2/DAA service as required where C2/DAA signaling integrity protection is either ‘Required or Preferred’ as configured (e.g., the U2X service security policy as part of the U2X security policy for the PC5 direct communication is provisioned to the UE based on phase-1 process described in this disclosure), key establishment information (Key_Est_Info), and security information.

In some implementations, when rekeying an existing connection with a second UE 204b (e.g., UAV/UAV-C), a first UE 204a (e.g., UAV) may send a Direct Rekeying Request message to the second UE instead of a Direct Communication Request.

In another embodiment, the sender of direct communication request at 605 may be a UAV-C 204b. Accordingly, for a C2 service, a UAV 204a may send the direct communication request to a UAV-C 204b, or a UAV-C 204a may send a direct communication request to a UAV. For a DAA service, one UAV may send a direct communication request to another UAV.

At 610, the method may include verifying the U2X service type and security policy in the direct communications request. On receiving the direct communication request at 605, if a U2X service type in the request indicates a C2 service, the UAV-C 204b may verify the locally configured U2X security policy which may include a pairing restrictions list. If the received UAV ID is the same as any UAV ID in the pairing restrictions list, then the UAV-C 204b may determine to respond and establish secure communications with the UAV 204a by performing direct authentication and key establishment.

If the UAV ID in the direct communication request does not match with any UAV ID in the pairing restrictions list, then the UAV-C 204b may determine to not respond or to reject the direct communication request, in which case the UAV-C 204b may skip steps 615-630 and perform step 635. If the U2X service security policy indicates C2 signaling security is ‘NOT Needed’ while the locally configured U2X service security policy indicates C2 signaling security is ‘Required’, the UAV-C 204b can reject the direct communication request for the U2X C2 service type.

In some implementations, based on local configuration of C2 pairing information, the UE 204 receiving the direct communication request, which could be a UAV or a UAV-C, checks if it is authorized to initiate security establishment with the requestor. If the requestor's ID is configured in pairing information, the receiver can perform steps 615-630. Otherwise, the requestor may send a direct communication reject message with policy violation cause information. It is emphasized that even though FIG. 6 illustrates a UAV 204a transmitting a direct communication request to a UAV-C 204b, in another embodiment, a UAV-C may transmit a direct communication request to an UAV, or a UAV may transmit a direct communication request to another UAV.

In some implementations, on receiving the direct communication request, if the U2X service type indicates DAA service, the UAV 204a may verify the locally configured U2X security policy which includes an access restriction list. If the received UAV ID does not match any UAV ID in the access restriction list, then the UAV 204a determines to respond and establishes secure communications with the UAV by performing direct authentication and key establishment in steps 615-630. If the UAV ID in the direct communication request matches a UAV ID in the access restriction list, then the UAV 204a determines to not respond or to reject the direct communication request, in which case the UAV 204a may skip steps 615-630 and perform step 635.

In some implementations, if the U2X service security policy indicates DAA signaling security is ‘NOT Needed’, while the locally configured U2X service security policy indicates DAA signaling security is ‘Required’, the UAV 204a may reject the direct communication request for the U2X DAA service type.

At 615, the method may include performing direct authorization and key establishment. After verification at 610, if the UE 204 that receives the direct communications request determines to respond, it may initiate the direct authentication and key management procedure to generate the key (e.g., 256-bit root key that is shared between the two entities that communicates using NR PC5 unicast link) and it may send key establishment information (Key_Est_Info) at 615. Based on the configured U2X security policy and received U2X service security policy, a UAV-C 204b may determine to apply confidentiality and integrity protection to the signaling and user plane specific to the C2 as indicated in the U2X service type. In an embodiment, based on the configured U2X security policy and received U2X service security policy, a UAV 204a may determine to apply confidentiality and integrity protection to the signaling and user plane specific to the DAA as indicated in the U2X service type. In another embodiment, a UAV 204a may perform step 615 when the received U2X service type indicates ‘DAA’.

At 620, the method may include receiving a direct security mode command. At 620, the UAV-C 204b may transmit a direct security command to the UAV 204a. The Direct security mode command may include Key_Est_Info, MSB of Key ID (e.g., KNRP ID), a U2X service type, the U2X service security policy received at 605, and its own U2X service security policy. One or both of a confidentiality key and the integrity key may be derived to protect the U2X service as indicated and determined by the U2X service security policy. In an embodiment, a least significant bit (LSB) of a Key ID may be transmitted at 620. The direct security mode command may be a direct security mode message including one or more of: information elements of a received U2X service type in the request 605, information elements of the U2X security policy in the request 605, a security capability, or the U2X security policy received from the UAV and an agreed U2X service security policy. At 625, the method may include transmitting a direct security mode complete message.

At 625, the UAV 204a may confirm that the returned security capabilities, U2X service type and U2X service security policy are the same as those it sent at 605. If this check is successful, the UAV 204a, on receiving the direct security mode command, may derive the key and choose a LSB of a Key ID (e.g., KNRP ID) to uniquely identify the Key and locally store the key and the ID based on received Key_Est_Info. Then the UAV 204a may send, to the UAV-C, the direct security mode complete message which includes one or more of the LSB of the Key ID, security capabilities, a U2X service type, and U2X service security policy sent at 605. The confidentiality key and the integrity key may be derived to protect the U2X service as indicated and determined by the U2X service security policy. The UE 204a may transmit, to the UAV-C 204b, information elements from the request 605 at 625.

In some implementations, the lower layer may be provided with an indication before sending a direct communication accept message to indicate that the signaling message starting with the direct communication accept is protected with the new security context and an indication after sending the direct communication accept message to indicate that the user plane traffic is protected with the new security context. The UAV-C 204b may delete any old security context it has for the UAV 204a. In an embodiment, the most significant bit (MSB) of the Key ID may be transmitted at 625.

At 630, the method may include receiving a direct communication accept message. At 630, the UAV-C 204b may send a direct communication accept message over the established link, which may be integrity and confidentiality protected, with a success and U2X service code to identify the successful U2X service connection and the associated context. The direct communication accept message may include an indication that the direct communication request at 605 is accepted or rejected. The UAV and UAV-C may then start C2 communications over PC5.

After receiving the direct communication accept message, the lower layer of UAV may be provided with an indication of activation of U2X PC5 unicast user plane security protection for the U2X PC5 unicast link, if applicable. At this point, the UAV is now ready to send and receive user plane traffic protected with the new security context. The UAV may delete any old security context it has for the UAV-C.

At 635, the method may include rejecting a direct communication request. If the U2X security policy is not met and/or if authentication fails in previous steps, a UAV 204a or UAV-C 204b may send a direct communication reject or failure message, which may include a U2X service error along with a cause value. Possible U2X service error cause values include C2 not allowed, DAA forbidden, DAA failed, C2 failed, authentication failed, service not allowed, service forbidden, etc. The direct communication reject message may include an indication that the direct communication request at 605 is rejected.

On failure, the UAV 204a and UAV-C 204b may store and maintains the U2X service type, agreed security capabilities, U2X service security policy, U2X security policy, target UAV/UAV-C ID(s) and U2X service code. The U2X service code can be alternatively known as a U2X PC5 service code, which can be used to identify and manage the U2X PC5 established context.

The security capabilities mentioned in process 600 indicate the confidentiality and integrity algorithms to be used for the U2X service direct communication.

Embodiments are applicable to an evolved packet system (EPS). U2X service direct connection establishment procedure described above can be applicable to an EPS, with the adaptation of MME instead of AMF, S-GW+PGW-C instead of SMF, and with the Home Subscriber Service/Authentication Center (HSS/AuC) instead of UDM. A UAS NF 206b of the 3GPP network can be a standalone network function, or a service offered by the SCEF in the EPS instead of NEF in the 5GS.

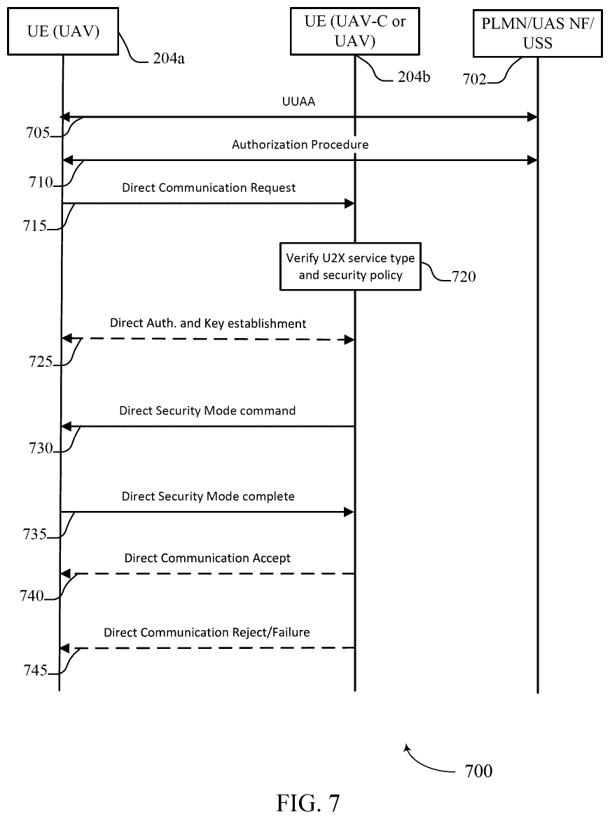

FIG. 7 illustrates a signal diagram of another embodiment of a method 700 of establishing direct U2X service secure connections for C2 or DAA services. The signaling diagram 700 may implement aspects of the wireless communications system 100 and the wireless communications system 200 as described with reference to FIGS. 1 and 2, respectively. For example, the operations of the method 700 may be implemented by a UE 204 including a UAV 204a and UAV-C 204b as described with reference to FIGS. 1 through 2.

UAV-to-Everything (U2X) services such as C2 and direct DAA can utilize a PC5 link for establishing C2 connection between a UAV and UAV-C, and for establishing unicast connection for DAA between UAVs respectively as discussed in TR 23.700-58. Elements of method 700 may be the same as or similar to elements of methods 400, 500 and 600 described above. In the interest of brevity, the following description of method 700 does not include every detail discussed above.

At 705, a UUAA procedure is performed by one or more of a UAV 204, UAV 204, or PLMN/UAS NF/USS 702. If the UAV 204a is capable of Uu communication, the UAV may perform a UUAA procedure and C2 authorization as described in TS 23.256 and TS 33.256. The UAV 204a obtains UAV-C pairing information (if not configured already) and a U2X security policy for each U2X service (e.g. C2, DAA, remote ID broadcast etc.,) along with the result of successful UUAA or C2 authorization. The U2X security policy may include one or more of: signaling and user plane protection security requirements/policy per U2X service type (for C2 and DAA, remote ID broadcast the signaling and user plane confidentiality and integrity may be set based on local policy), a pairing restrictions list, access restriction information, broadcast group restrictions etc.

At 710, the method may include performing an authorization procedure. In an embodiment, a UAV-C 204 can also perform UUAA procedures and C2 authorization as described in TS 23.256 and TS 33.256. The UAV-C 204b obtains UAV pairing information (if not configured already) and a U2X security policy for each U2X service (C2 and DAA) along with the result of successful C2 authorization.

At 715, a UAV 204a transmits a direct communication request to another UAV or UAV-C 204b. In the case of C2 communications, if the UAV 204a sets up C2 communication over PC5, the UAV 204a may send a direct communication request with a U2X service type which indicates one or more of a C2 service, a UAV identifier (i.e., a CAA-Level UAV ID), a UAV-C identifier, a U2X service security policy specific to the C2 service (confidentiality and integrity protection requirements for signaling and user plane protection), and security capability and key establishment information (as described in TS 33.536) which may also include security information for C2 security. When the UAV 204a sends a direct communication request for C2, then the UAV 204a may set the security capability to any non-null algorithms for confidentiality and integrity protection.

If the UAV 204a (e.g., a first UAV) sets up a DAA connection over PC5, the UAV 204a may send a direct communication request with one or more of a U2X service type which indicates DAA service, a UAV identifier (CAA-Level UAV ID), a U2X service security policy specific to the DAA service (confidentiality and integrity protection requirements for signaling and user plane protection), and security capability and key establishment information (as described in TS 33.536) which can also include security information for DAA security. If the UAV 204a sends a direct communication request for DAA, then UAV may set the security capability to any non-null algorithms for confidentiality and integrity protection.

At 720, the method may include verifying a U2X service type and security policy. At 720, on receiving the direct communication request from UAV 204a, if the U2X service type indicates a C2 service, the UAV-C 204b verifies the received U2X service security policy and UAV ID against the locally configured U2X security policy which may include the pairing restrictions list and U2X service security policy. If the received UAV ID is the same as any UAV ID in the pairing restrictions list and if the U2X service security policy matches with the locally stored one, then the UAV-C 204b performs direct authentication and key establishment at 725.

If the UAV ID in the direct communication request do not match with any UAV ID in the pairing restrictions list or if the received U2X service security policy violates the locally configured U2X service security policy for the C2 service, then the UAV-C 204b rejects the direct communication, and the UAV-C 204b proceeds to 745.

At 720, on receiving the direct communication request, if the U2X service type indicates a DAA service, the second UAV 204a verifies the received U2X service security policy and UAV ID against the locally configured U2X security policy which may include access restriction information and a U2X service security policy. If the received UAV ID is not present in the access restriction information, and if the U2X service security policy matches with the locally stored one, then the UAV 204 performs direct authentication and key establishment at 725.

If the UAV ID in the direct communication request matches with any of the UAV IDs in the access restriction information or if the received U2X service security policy violates the locally configured U2X service security policy for the DAA service, then the UAV 204a rejects the direct communication and proceeds to 745.

At 725, the method may include direct authentication and key establishment. A UAV-C 204 may perform direct authentication and key establishment as described in TS 33.536 with a UAV 204 at 725. In another embodiment, a UAV 204a may perform direct authentication and key establishment as described in TS 33.536 with another UAV at 725.

At 730, the method may include receiving a direct security mode command. For C2 communications, the UAV-C 204b sends a direct security mode command which includes information including Key_Est_Info, MSB of Key ID (e.g., KNRP ID to indicate the C2 security key), received UAV ID, its own UAV-C ID, security capabilities, and additional information such as those received at 705 and 710 (U2X service type, U2X service security policy, UAV ID and the actual UAV-C ID) to the UAV at 730. The session key (a C2 session key), PC5 signaling and user plane keys (for confidentiality and integrity) may be derived to protect the C2 service based on the U2X service security policy.

For DAA communications, the second UE 204b (e.g., UAV or UAV-C) sends the Direct security mode command which includes information including Key_Est_Info, MSB of Key ID (e.g., KNRP ID to indicate the DAA security key), received UAV ID, its own UAV ID, security capability, and additional information such as those received at 705 and 710 (i.e., U2X service type, U2X service security policy, received UAV's ID and its own UAV ID) to the first UE 204 (e.g. UAV). The session key (a DAA session key), PC5 signaling and user plane keys (for confidentiality and the integrity) may be derived to protect the DAA service based on the U2X service security policy.

At 735, the method may include transmitting a direct security mode complete message. For C2 communications, the UAV 204a checks that the returned security capabilities, U2X service type and U2X service security policy are the same as those it sent at 705 and 710. The UAV 204a, on receiving the direct security mode command, if the above check is successful, based on received Key_Est_Info (as in TS 33.536) derives the key and choose a LSB of a Key ID (e.g., KNRP ID) to uniquely identify the Key and locally store the key with the identifier. Then the UAV 204a sends to the UAV-C 204b, the direct security mode complete message which includes the LSB of the Key ID, security capabilities, UAV ID, U2X service type, and U2X service security policy sent at 705 and 710. The confidentiality key and the integrity key (e.g., C2 encryption and integrity keys) can be derived to protect the C2 service based on the U2X service security policy.

For DAA communications, the UAV 204a checks that the returned security capabilities, U2X service type and U2X service security policy are the same as those it sent at 705 and 710. The UAV 204a, on receiving the direct security mode command, if the above check is successful, based on received Key_Est_Info (as in TS 33.536) derives the key (e.g., DAA session key) and choose a LSB of a Key ID (e.g., KNRP ID) to uniquely identify the Key and locally store the key with the identifier. Then the UAV (e.g., UAV 1) sends to the UAV (e.g., UAV 2), the Direct security mode complete message which includes the LSB of the Key ID, security capabilities, UAV ID, U2X service type, and U2X service security policy sent at 705 and 710. The confidentiality key and the integrity key (e.g., DAA encryption and integrity key) can be derived to protect the DAA service based on the U2X service security policy.

At 740, the method may include receiving a direct communication accept message. For C2 communications, the UAV-C 204b sends a Direct Communication Accept message over the established link. The UAV 204a and UAV-C 204b can then start C2 communication over PC5. For DAA communications, the second UAV 204b sends a Direct Communication Accept message over the established link. The UAVs can then start DAA communication over PC5.

At 745, the method may include receiving a direct communication reject or failure message. For C2 communications, the UAV-C 204b sends a direct communication reject message if the U2X security policy is not met, if authentication and key establishment fails or if the direct security mode command procedure fails, with respective cause information. For DAA communications, the second UAV 204b sends a direct communication reject message if the U2X security policy is not met, if authentication and key establishment fails or if the direct security mode command procedure fails with respective cause information.

In an embodiment, a UAV 204a and UAV-C 204b may derive a C2 key (e.g., a 256-bit root key that is shared between the two entities that communicating using NR PC5 unicast link for C2 connection), a C2 session key (e.g., KNRP-session and may be derived from C2 Key), a C2 encryption Key and C2 integrity keys (may be derived from C2 session Key) as appropriate.

For Direct UAV to UAV communications for DAA, UAVs can use PC5 (e.g., C-V2X) as described in TR 23.700-58 Clause 5.3. To enable confidentiality, integrity, and relay protection for DAA related unicast connection, the procedure described using FIG. 2 can be performed as indicated above.

In an embodiment, first and second UAVs can derive a DAA key (e.g., a 256-bit root key that is shared between the two entities that communicating using NR PC5 unicast link for DAA connection), a DAA session key (e.g., KNRP-session and may be derived from DAA Key), a DAA encryption Key and DAA integrity keys (may be derived from DAA session Key) as appropriate.

Secure U2X service direct communication establishment is shown in FIG. 7 and described above can be applicable to EPS, with the adaptation of MME instead of AMF, S-GW+PGW-C instead of SMF, with the HSS/AuC instead of UDM. UAS NF 206b of the 3GPP network can be a standalone network function, or a service offered by the Service Capability Exposure Function (SCEF) in the EPS instead of NEF in the 5GS.

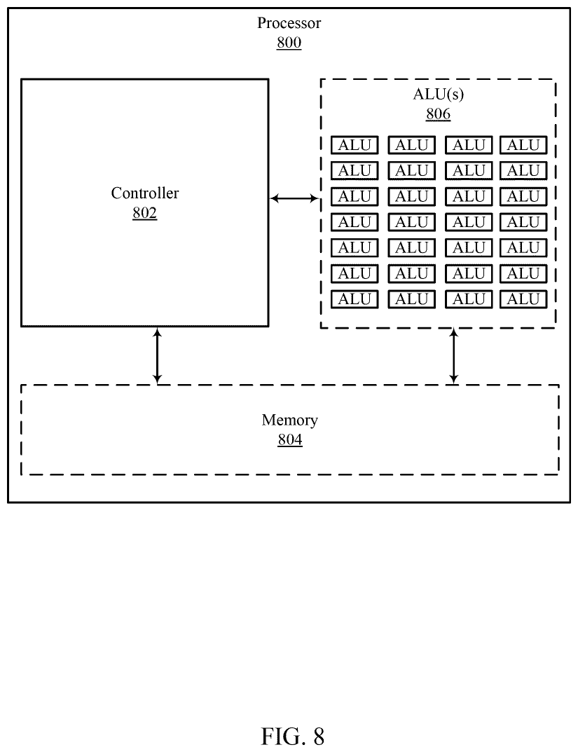

FIG. 8 illustrates an example of a processor 800 that supports secure UAV communications in accordance with aspects of the present disclosure. The processor 800 may be an example of a processor configured to perform various operations in accordance with examples as described herein. The processor 800 may include a controller 802 configured to perform various operations in accordance with examples as described herein. The processor 800 may optionally include at least one memory 804, such as L1/L2/L3 cache. Additionally, or alternatively, the processor 800 may optionally include one or more arithmetic-logic units (ALUs) 800. One or more of these components may be in electronic communication or otherwise coupled (e.g., operatively, communicatively, functionally, electronically, electrically) via one or more interfaces (e.g., buses).

The processor 800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 802 may be configured to manage and coordinate various operations (e.g., signaling, receiving, obtaining, retrieving, transmitting, outputting, forwarding, storing, determining, identifying, accessing, writing, reading) of the processor 800 to cause the processor 800 to support various operations in accordance with examples as described herein. For example, the controller 802 may operate as a control unit of the processor 800, generating control signals that manage the operation of various components of the processor 800. These control signals include enabling or disabling functional units, selecting data paths, initiating memory access, and coordinating timing of operations.

The controller 802 may be configured to fetch (e.g., obtain, retrieve, receive) instructions from the memory 804 and determine subsequent instruction(s) to be executed to cause the processor 800 to support various operations in accordance with examples as described herein. The controller 802 may be configured to track memory address of instructions associated with the memory 804. The controller 802 may be configured to decode instructions to determine the operation to be performed and the operands involved. For example, the controller 802 may be configured to interpret the instruction and determine control signals to be output to other components of the processor 800 to cause the processor 800 to support various operations in accordance with examples as described herein. Additionally, or alternatively, the controller 802 may be configured to manage flow of data within the processor 800. The controller 802 may be configured to control transfer of data between registers, arithmetic logic units (ALUs), and other functional units of the processor 800.

The memory 804 may include one or more caches (e.g., memory local to or included in the processor 800 or other memory, such RAM, ROM, DRAM, SDRAM, SRAM, MRAM, flash memory, etc. In some implementation, the memory 804 may reside within or on a processor chipset (e.g., local to the processor 800). In some other implementations, the memory 804 may reside external to the processor chipset (e.g., remote to the processor 800).

The memory 804 may store computer-readable, computer-executable code including instructions that, when executed by the processor 800, cause the processor 800 to perform various functions described herein. The code may be stored in a non-transitory computer-readable medium such as system memory or another type of memory. The controller 802 and/or the processor 800 may be configured to execute computer-readable instructions stored in the memory 804 to cause the processor 800 to perform various functions. For example, the processor 800 and/or the controller 802 may be coupled with or to the memory 804, and the processor 800, the controller 802, and the memory 804 may be configured to perform various functions described herein. In some examples, the processor 800 may include multiple processors and the memory 804 may include multiple memories. One or more of the multiple processors may be coupled with one or more of the multiple memories, which may, individually or collectively, be configured to perform various functions herein.

The one or more ALUs 800 may be configured to support various operations in accordance with examples as described herein. In some implementation, the one or more ALUs 800 may reside within or on a processor chipset (e.g., the processor 800). In some other implementations, the one or more ALUs 800 may reside external to the processor chipset (e.g., the processor 800). One or more ALUs 800 may perform one or more computations such as addition, subtraction, multiplication, and division on data. For example, one or more ALUs 800 may receive input operands and an operation code, which determines an operation to be executed. One or more ALUs 800 be configured with a variety of logical and arithmetic circuits, including adders, subtractors, shifters, and logic gates, to process and manipulate the data according to the operation. Additionally, or alternatively, the one or more ALUs 800 may support logical operations such as AND, OR, exclusive-OR (XOR), not-OR (NOR), and not-AND (NAND), enabling the one or more ALUs 800 to handle conditional operations, comparisons, and bitwise operations.

The processor 800 may support wireless communication in accordance with examples as disclosed herein. The processor 800 may be configured to or operable to support a means for secure UAV communications.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1-20. (canceled)

21. A user equipment (UE) for wireless communication, comprising:
at least one memory; and
at least one processor coupled with the at least one memory and configured to cause the UE to:
receive an aircraft-to-everything (A2X) security policy;
send, to an uncrewed aerial vehicle (UAV) controller (UAV-C), a request for direct communication and associated with a UAV service, wherein the request includes the A2X security policy; and
receive, from the UAV-C, a response based at least in part on verifying the A2X security policy, wherein the response indicates whether the request for the UAV service is accepted or rejected.

22. The UE of claim 21, wherein the UAV service comprises a command and control (C2) service or a detect and avoid (DAA) service.

23. The UE of claim 21, wherein the A2X security policy comprises one or more of: an A2X PC5 security policy for A2X C2 and DAA services,
an A2X C2 security policy for one or both of signaling and user plane operations, and
an A2X DAA security policy for one or both of signaling and user plane operations.

24. The UE of claim 21, wherein the A2X security policy is a C2 security policy, and signaling and user plane security operations are set as required based on local policy.

25. The UE of claim 21, wherein the request comprises one or more of a UAV identifier, a UAV-C identifier, a security capability for the direct communication, or security key information.

26. The UE of claim 21, wherein at least one processor is configured to cause the UE to:
receive, from the UAV-C, a direct security mode message including one or more of: information elements of a received A2X service type in the request, information elements of the A2X security policy in the request, s security capability, or the A2X security policy received from the UAV and an agreed A2X service security policy.

27. The UE of claim 21, wherein the A2X service type comprises a detect and avoid (DAA) service, and wherein at least one processor is configured to cause the UE to:
transmit a second request to a second UAV.

28. The UE of claim 27, wherein the second request is a second request for direct communications associated with the DAA service.

29. A processor for wireless communication, comprising:
at least one memory; and
a controller coupled with the at least one memory and configured to cause the controller to:
receive an aircraft-to-everything (A2X) security policy;
send, to an uncrewed aerial vehicle (UAV) controller (UAV-C), a request for direct communication and associated with a UAV service, wherein the request includes the A2X security policy; and
receive, from the UAV-C, a response based at least in part on verifying the A2X security policy, wherein the response indicates whether the request for the UAV service is accepted or rejected.

30. The processor of claim 29, wherein the UAV service comprises a command and control (C2) service or a detect and avoid (DAA) service.

31. The processor of claim 29, wherein the A2X security policy comprises one or more of:
an A2X PC5 security policy for A2X C2 and DAA services,
an A2X C2 security policy for one or both of signaling and user plane operations, and
an A2X DAA security policy for one or both of signaling and user plane operations.

32. The processor of claim 29, wherein the A2X security policy is a C2 security policy, and signaling and user plane security operations are set as required based on local policy.

33. The processor of claim 29, wherein the request comprises one or more of a UAV identifier, a UAV-C identifier, a security capability for the direct communication, or security key information.

34. The processor of claim 29, wherein the memory is configured to cause the controller to:
receive, from the UAV-C, a direct security mode message including one or more of: information elements of a received A2X service type in the request, information elements of the A2X security policy in the request, a security capability, or the A2X security policy received from the UAV and an agreed A2X service security policy.

35. The processor of claim 29, wherein the A2X service type comprises a detect and avoid (DAA) service, and wherein at least one processor is configured to cause the UE to:
transmit a second request to a second UAV.

36. The processor of claim 35, wherein the second request is a second request for direct communications associated with the DAA service.

37. A method performed by a user equipment (UE), the method comprising:
receiving an aircraft-to-everything (A2X) security policy;
sending, to an uncrewed aerial vehicle (UAV) controller (UAV-C), a request for direct communication and associated with a UAV service, wherein the request includes the A2X security policy; and
receiving, from the UAV-C, a response based at least in part on verifying the A2X security policy, wherein the response indicates whether the request for the UAV service is accepted or rejected.

38. The method of claim 37, wherein the UAV service comprises a command and control (C2) service or a detect and avoid (DAA) service.

39. The method of claim 37, wherein the A2X security policy comprises one or more of: an A2X PC5 security policy for A2X C2 and DAA services,
an A2X C2 security policy for one or both of signaling and user plane operations, and
an A2X DAA security policy for one or both of signaling and user plane operations.

40. The method of claim 37, wherein the A2X security policy is a C2 security policy, and signaling and user plane security operations are set as required based on local policy.
